(19) United States
(12) Patent Application Publication
(10) Pub. No.: US 2006/0206894 A1
(43) Pub. Date: Sep. 14, 2006

(54) Method of scheduling jobs using database management system for real-time processing

(75) Inventors: Yong Seok Jung, Daegu (KR); Jin Ho Lee, Daegu (KR)

Correspondence Address: NIXON PEABODY, LLP, 401 9TH STREET, NW, SUITE 900, WASHINGTON, DC, 20004-2128, US

(73) Assignee: FUSIONSOFT CO., LTD., Daegu-si (KR)

(21) Appl. No.: 11/369,820

(22) Filed: Mar. 8, 2006

(30) Foreign Application Priority Data
Mar. 9, 2005 (KR) P.10-2005-0019567

(51) Int. Cl. G06F 9/46

(52) U.S. Cl. 718/100; 718/101

(57) ABSTRACT

A method of scheduling jobs in real time using a database management system is provided. An application task classifies jobs as any one transaction type of a hot type and a normal type. A processing area in a memory pool that is a common resource is allocated to the application task, and the job is transferred to a database job manager through a client application program interface (API). The job manager loads a request node of the job in a list of a transaction type corresponding to the job, of a mailbox of the DB task, which classifies job request nodes as the hot type and the normal type with respect to the type of transaction and manages the nodes, so that the job request node can be scheduled in units of transactions. The job manager transfers the job request nodes loaded in the mailbox for the DB task, one by one to the DB task so that the job request nodes can be processed in units of transactions in a manner in which a job corresponding to a hot-type transaction is processed with a priority over a job corresponding to a normal-type transaction, and between jobs of an identical truncation type, jobs are processed in order of job requesting time. The DB task loads through the job manager, the processing result of the job in a mailbox of the application task which requested the processing of the job, so that the corresponding application task can use the processing result in the future.

### CROSS-REFERENCE TO RELATED PATENT APPLICATIONS

This application claims the benefit of Korean Patent Application No. 10-2005-0019567, filed on Mar. 9, 2005, in the Korean Intellectual Property Office, the disclosure of which is incorporated herein in its entirety by reference.

### BACKGROUND OF THE INVENTION

1. Field of the Invention

The present invention relates to a method of processing jobs in relation to a database, and more particularly, to a method of scheduling in real time, jobs in relation to a database operating on a real-time operating system in a mobile communication terminal.

2. Description of the Related Art

With the recent development of multimedia and network fields, an embedded system has become to include functions for processing multimedia information and connecting a network, and the structure of the embedded system has become more complicated. In a simple embedded system used previously, a sequential design was good enough for simple functions. However, as the embedded system becomes complicated, a new method different from the conventional method is needed. As the jobs that should be processed increase, a multitasking function for a complicated system is also needed. As a result, an operating system (OS) used only in a computer system is now required in the embedded system. Furthermore, most of embedded systems were required to satisfy a characteristic of real time processing, and as a result, a real-time operation system (RTOS) has appeared.

The RTOS is an operating system that, if an event occurs inside and/or outside a system to which the RTOS is applied, makes a delay time from the occurrence of the event to a time when processing of the event begins, not exceed a predetermined time. In a system employing an RTOS (a real-time system), an occurrence of an event and processing of the event are performed in real time, and a predetermined job is necessarily performed in a predetermined time. For example, mobile communication devices, such as a mobile communication terminal, a smart phone, a personal digital assistant (PDA), a wireless Internet terminal, and a car navigation system, and portable terminals for a special purpose, such as sales, marketing, and stock management, are real time system using the RTOS as other embedded systems.

Meanwhile, the variety of portable communication devices mentioned above, including the portable communication terminal, are continuously evolving and their functions are becoming more sophisticated and complicated. The portable communication devices have been changing and evolving continuously through fusion between heterogeneous devices, for example, fusion of a digital camera and a portable phone, fusion of an MP3 layer and a portable phone, and introduction of a TV reception function into a portable phone. In these portable communication devices, the amount of information to be managed and processed increases, and the contents of information processing jobs become more complicated, diversified, and sophisticated. Accordingly, in order to efficiently manage and process the information, introduction of means for performance improvement in terms of both hardware and software is needed, and as an example of these means, introduction of a database system can be considered.

However, so far there has been no precedence of introduction and commercialization of a database system in a portable communication terminal. In a conventional portable communication terminal, for example, a phone book is implemented by using a file system utilizing a data structure. However, when the trend and speed of evolution of a mobile communication terminal are considered, introduction of a database system into a mobile communication terminal can be regarded as a matter of time.

### SUMMARY OF THE INVENTION

A mobile communication terminal needs a real-time communication function and a data confirmation function as essential functions. For example, if a call is received at a mobile phone while a user of the mobile phone searches a telephone number with it, display of the name of the caller corresponding to a received telephone needs to be processed in real time. If a database system (for example, a relational database system) is employed in a mobile communication terminal running under an RTOS environment, jobs utilizing the database (for example, jobs such as displaying the name of a caller, when a yellow book is built as a database) should also be processed in real time as an essential requirement. Furthermore, in processing jobs utilizing the database, integrity of the database should also be guaranteed perfectly. In addition, a variety of functions required to more efficiently perform jobs related to the database should also be supported together.

Accordingly, considering these needs, the present invention provides a method of scheduling database jobs, by which the order of processing jobs using a database running under an RTOS environment of a mobile communication terminal can be flexibly scheduled according to urgency of jobs, and at the same time, by employing a memory pool as a common resource, only address information is actually transferred, and by introducing a time-out system (job time restriction system), real-time processing of jobs can be guaranteed and by processing jobs in units of transactions, integrity of a database can be guaranteed.

According to an aspect of the present invention, there is provided a method of scheduling jobs using a database management system for real time processing, the method includes: an application task classifying a job which is requested to be processed at a database (DB) task, as any one transaction type of a hot type and a normal type, requesting a memory pool shared by tasks of the database management system, so that a processing area for the job is allocated, and then, requesting a database job manager to process the job, through a client application program interface (API); the job manager identifying the type of transaction of the job which the application task requests to be processed, generating a job request node of the job, and loading the request node of the job in a list of a transaction type corresponding to the job, of a mailbox of the DB task, so that the job request node can be scheduled in units of transactions; and the job manager transferring the job request nodes loaded in the mailbox for the DB task, one by one to the DB task so that the job request nodes can be processed in units of transactions in a manner in which a job corresponding to a hot-type transaction is processed with a priority over a job corresponding to a normal-type transaction, and between jobs of an identical truncation type, jobs are processed in order of job requesting time.

According to the scheduling method, in order to process jobs in a database in real time under an RTOS environment used in a mobile communication terminal, jobs to be performed are classified as a normal type and a hot type. Between normal-type jobs or between hot-type jobs, a job processing order is set basically as a first-in-first-out (FIFO) method, and in order of requesting time, jobs are processed such that a real-time property can be guaranteed. However, between a normal-type job and a hot-type job, the latter is processed with a priority over the former. That is, if a hot-type job which needs to be processed urgently is requested, an interrupt is generated regardless of the FIFO job order, a job being performed previously is temporarily stopped, and then hot-type jobs are processed with a priority before normal-type jobs. Then, the processing of the normal-type jobs that is temporarily stopped is resumed. Through this method, efficient job scheduling and real-time characteristic of the database management system (DBMS) can be guaranteed.

After the transferring and processing of the job request nodes, the scheduling method may further include: the DB task allocating the processed result of the job to the memory pool, and transferring the address of the memory pool in which the processed result is allocated, to the job manager, and the job manager loading the received the memory pool address to the mailbox of the application task requesting the processing of the job, so that the corresponding application task obtaining a control right from the real-time operating system can use the processed result loaded in the mail box of the application task in the future.

The scheduling method may further include: if the DB task does not complete the received job within a job restriction time, the DB task stopping the job being performed, recovering the original state of data changed in the execution of the job, then, returning the recovering result to the job manager, and then performing a job selected by the job manager through a job scheduling process.

In performing these operations, a memory pool is introduced as a common resource of an application task, a DB task, and a job manager. Actual data required to process their jobs and actual data as the processing results of the jobs are stored in this memory pool, while information exchanged among the application task, the DB task, and the job manager in order to request job processing and to receive the processing results of the jobs, is made to indicate address information of the memory pool storing the actual data required to process corresponding jobs and actual data as the processing results of the jobs. By doing so, an optimal method of processing jobs in a mobile communication terminal that essentially has a limited memory space, is suggested and in addition, by minimizing the amount of information transferred, jobs can be processed quickly.

Furthermore, job request nodes loaded on the mailbox for the DB task, forming an identical transaction, have identical transaction IDs, and are sequentially linked by pointers. When these jobs are transferred to the DB task through the job manager, jobs having identical transaction IDs, are made to be transferred continuously so that jobs can be bundled and processed in units of transactions. By doing so, integrity of the database can be guaranteed through job processing in units of transaction essentially required when a job using a database is performed.

The following process is performed so that a job request node can be loaded in a list of a transaction type corresponding to the node, of the mailbox of the DB task so as to be scheduled in units of transactions. First, the session ID and transaction ID of a job to be added are identified. Then, the values are compared and analyzed sequentially with the session IDs and transaction IDs of the entire transaction anchor nodes included in a transaction anchor list corresponding to the job and it is determined whether or not a transaction anchor node having the same session ID and transaction ID as those of the job to be added. If such a transaction anchor node exists, the job request node of the job is added to the transaction anchor node. If such a transaction anchor does not exist, a new transaction anchor node is generated and added to a corresponding transaction anchor list. Then, the job request node is added to the newly generated transaction anchor node. By doing so, jobs can be loaded in units of transactions.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a method of scheduling database jobs according to an embodiment of the present invention, in which an application task and a database (DB) task schedule jobs with a job manager as a medium, so that jobs can be processed in units of transactions in real time;

FIGS. 2 and 3 illustrate a structure of a mailbox of a DB task according to an embodiment of the present invention;

FIG. 4 illustrates a process of a job manager transferring jobs to a mailbox according to an embodiment of the present invention;

FIG. 5 illustrates in more detail a process (operation S22 or S24 of FIG. 4) of a job manager adding (storing) jobs in a normal- or hot-type transaction anchor list according to an embodiment of the present invention; and

FIG. 6 illustrates a process of a job manager scheduling jobs using a mailbox according to an embodiment of the present invention.

### DETAILED DESCRIPTION OF THE INVENTION

The present invention will now be described more fully with reference to the accompanying drawings, in which exemplary embodiments of the invention are shown.

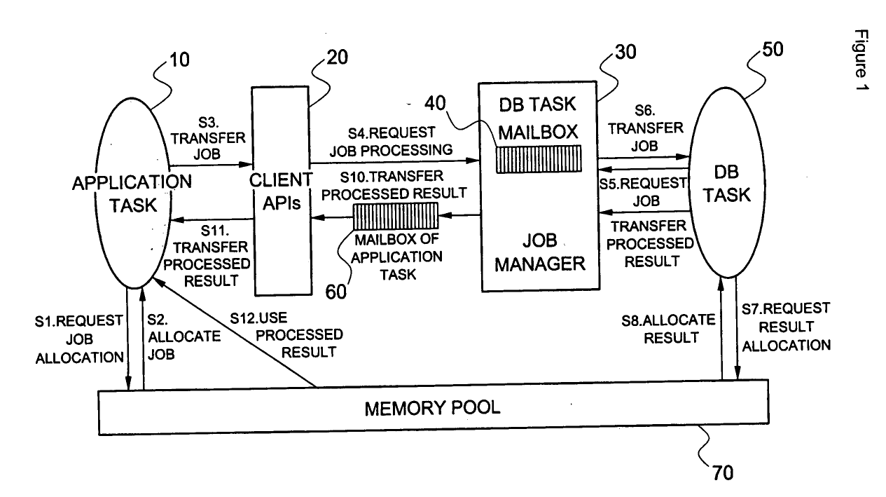

FIG. 1 illustrates a method of scheduling database jobs according to an embodiment of the present invention, in which an application task and a database (DB) task schedule jobs with a job manager as a medium, so that jobs can be processed in units of transactions in real time. Referring to FIG. 1, the shown system runs under an RTOS environment. An application task 10 requests a DB task 50 to process a job, receives the processed result, and uses the result. The DB task 50 processes the job in response to the request, and transfers the result to the application task 10. For reference, a task is a basic unit of a program which the RTOS controls. Depending on how a task is defined when an operating system is designed, a unit program that can be a task may be an entire program or a call of continuous programs. In the present invention, the ‘application task’ 10 means an arbitrary application program operating under an RTOS environment, and the ‘DB task’ 50 means a database server program operating under an RTOS environment. A ‘job’ means a query job that the application task 10 requests the DB task 50 to process.

This job is classified as one of a normal-type job and a hot-type job. The type of a job is set when the job is allocated in the application task 10.

A mobile communication terminal includes a plurality of tasks, and manages the operation of each task, by using the RTOS. Also, a memory pool 70 is disposed and is utilized as a common resource of the tasks. If the memory pool 70 is used, when the application task 10 requests the DB task to process a job, or reversely, the DB task 50 transfers the processing result of the job to the application task 10, in order to transfer the required data, the actual data value is not transferred but only the ‘address’ of the actual data stored in the memory pool 70 needs to be transferred. Accordingly, work load required to transfer data can be greatly reduced such that jobs can be processed more quickly.

A method of scheduling jobs for real-time processing of database jobs according to an embodiment of the present invention is performed as the following procedure.

(1) It is assumed that an application task 10 has a job that needs to be performed by using a database management system. In this case, the application task 10 should request the DB task 50 to process the job. For this, the application task obtaining a control right from the RTOS requests the memory pool 70 that is a common resource, to allocate the job to be processed and is allocated the job in operations S1 and S2. The memory pool 70 can be implemented by using, for example, a RAM. Through this process, a job area required for processing the allocated job is secured in the memory pool 70, and data related to the job is stored in the job area. As the job is allocated in the memory pool 70, what is actually transferred to the application task 10 is not ‘the actual data related to the job’, but ‘the address information of the allocated job space’, as described above. After the job is allocated, the application task 10 transfers the address of the job space allocated in the memory pool 70, to a parameter of a client application program interface (API) 20 and requests a job manager to process the job in operation S4. At this time, the information included in a message transferred when the application task 10 requests the job manager 30 to process the job through the client API 20, includes at least a structured query language (SQL) statement to be performed in order to process the job, an address of the memory pool 70 at which the transaction type of the job and information on a restriction time (time-out) to be applied to the processing of the job are stored, a primitive request having an identifier role to distinguish the requested job, and including an operation code to determine an execution method in the DB task 50.

(2) A job request and the processing result of the job should be exchanged between the application task 10 and the DB task 50, and in this case, the exchange can be performed through communication. This function is performed by a variety of tools supported in the RTOS. Representative tools include a variable using method that defines variables over a system for global use, a queue, a pipe, a mailbox, and a common memory. Among them, the mailbox is used in the present invention.

The job manager 30 generates a job request node, by adding additional information, such as a session ID and a transaction ID, in relation to the job which is requested to be processed, and loads the job request node in a mailbox 40 of the DB task so that the job request node can be classified according to the transaction type of the job through scheduling, and bundled in units of transactions. At this time, the information loaded in the mailbox 40 is the address of the memory pool 70 where data related to the job to be processed. The scheduling of the job which is requested to be processed will be explained in more detail later.

(3) Then, the DB task obtaining a control right from the RTOS requests the job manager 30 a job to be performed in operation S5, and the job manager 30 transfers the memory pool address at which a job selected through job scheduling is stored, to the DB task 50 in operation S6. In the process to process the job corresponding to the received memory pool address, the DB task 50 allocates the processing result in the memory pool 70 in operations S7 and S8, and then, transfers the memory pool address of the processing result to the job manager 30 in operation S4. Then, the job manager 30 loads the memory pool address of the processing result transferred by the DB task 50, in the mailbox 60 of the application task 10 requesting the processing of the job in operation S10.

(4) Then, the application task 10 obtaining again a control right from the RTOS receives the memory pool address of the processing result loaded in the mailbox transferred by the client API 20 in operation S11. Also, the application task 10 can access the received memory pool address and use the processing result stored at the address. That is, the application task 20 can perform the remaining jobs, such as calling the client API 20 again and processing the processing result stored in the memory pool 70.

(5) After performing a series of these jobs, the application task 10 calls the client API 20 again so that the allocated processing result and the job can be released from the allocation.

In this process, in order to maintain the relation with jobs of the application task 10, the job manager performs a session management function, such as generation, maintaining, and terminating of a session, and a time-out, a scheduling function to process a job order of requested jobs and a time-out, and a response processing function to transfer the processing result of a job to the mailbox 60 of the application task 10 requesting the processing of the job.

In the process shown in FIG. 1, all information items required for communication between the application task 10 and the DB task 50 are transferred in the form of a job request node composed of a session ID, a transaction ID, a primitive request, a primitive response, a transaction type, a time-out, a statement, and a result set.

Information items composing the job request node will now be explained in more detail.

A) Session ID: A predetermined unique ID of a task requesting a job processing is used.

B) Transaction ID: When a job is requested, a unique ID is generated and used.

C) Primitive request and primitive response: These are operation codes to determine an execution method in the DB task 50. Values of the operation codes forming these are as follows:

typedef enum
{

| | |
|---|---|
| DBOPen, | /* Database Open Request */ |
| DBClose, | /* Database Close Request */ |
| DBExecute, | /* Databse Execute Request */ |
| .... | |
| DBDone, | /* Database Execute Done Response */ |
| DBFail | /* Database Execute Fail Response */ |

} PRIMITIVE

D) Transaction type: According to the type of a job requested by the application task 10, the transaction type is set as a hot type or a normal type.

typedef enum
{

| | |
|---|---|
| Normal, | /*Normal type */ |
| Hot | /* Hot type */ |

} DB_TRANSACTION_TYPE;

E) Time-out: This sets a time restriction item of the job which is requested to the DB task 50 to process.

F) Instruction: This includes a query statement to be executed.

G) Result set: This stores information on a processed result. Here, the numbers of selected rows and columns, the address of the processed result data allocated to the memory pool 70, and an error message.

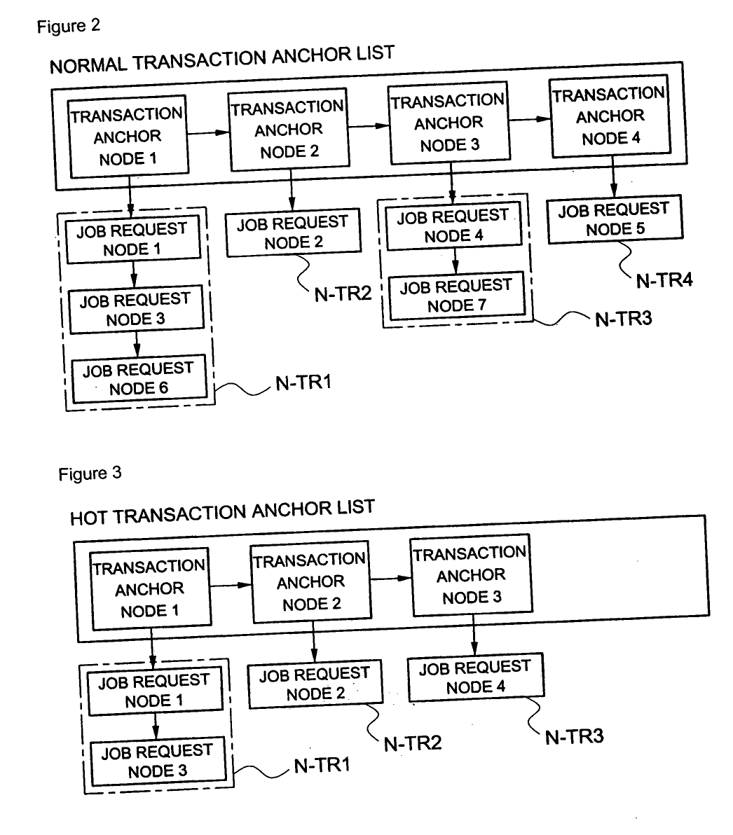

Next, FIGS. 2 and 3 show a structure of the mailbox 40 of the DB task 60. The mailbox 40 plays a role of a message storage place for communication between tasks. The job manager 30 manages jobs in units of ‘transactions’ by using session information and through the mailbox 40. The session information specifies the relation with an application task requesting a job. By using the session information, the job manager 30 specifies a job order in units of transactions in a job scheduling process, and determines an application task to which the processing result of the requested job is transferred.

The mailbox 40 of the DB task 50 two transaction anchor node lists as illustrated. One is a normal-type transaction anchor list loading normal-type jobs as illustrated in FIG. 2, and the other is a hot-type transaction anchor list loading hot-type jobs as illustrated in FIG. 3. Each transaction anchor node list is a linked list of transaction anchor nodes. A transaction anchor node has information to execute jobs in units of transactions.

Jobs (for example, ‘job request node 1’, ‘job request node 3’, and ‘job request node 6’ in FIG. 2) linked to one transaction anchor node (for example, ‘transaction anchor node 1’ of FIG. 2) belong to an identical transaction.

One transaction anchor node has a list of job request nodes, a session ID, a transaction ID, and a pointer to the mail box 40 of the application task 50 to which the processed result of jobs will be transferred. One job request node has information on an execution method of a job. The session ID is information used in a process to transfer the processing result of jobs to tasks, and a process of processing jobs in units of transactions. For example, the session ID is used by the job manager 30 to distinguish an application task requesting a job. The session ID needs to be assigned so that the uniqueness can be maintained. For example, as an embodiment, unique IDs of tasks assigned by the RTOS can be used as session ID. A transaction ID is used in a process in which when the job manager 30 manages jobs in units of transactions, the job manager classifies jobs and processes jobs of identical transaction IDs as one processing unit. Job request nodes belonging to an identical transaction are assigned identical transaction IDs.

A program code illustrated below defines structure forms of a job request node and a transaction anchor node.

typedef struct
{

| /* Job request node to be added next is indicated */ | | |
|---|---|---|
| struct JobRequestNode* | pNext; | |
| UINT16 | SessionID; | |
| UINT16 | TransactionID; | |
| UINT16 | Prim_Request; | |
| UINT16 | Prim_Response; | |
| DB_TRANSACTION_TYPETransactionType; | | |
| UINT16 | TimeOut; | |
| DB_Statement* | Statement; | /* Statement */ |
| DB_Result* | ResultSet; | /* Processing |

result of job */

} JobRequestNode;
typedef struct
{

| /* Transaction anchor node to be added next is indicated */ | |
|---|---|
| struct TransactionAnchorNode* | pNext; |

| /* First node of job request nodes bundled as a transaction is | |
|---|---|
| indicated */ | |
| struct JobRequestNode* | pJobRequestNode; |
| UINT16 | SessionIDD; |
| UINT16 | TransactionID; |
| Mail_BOX* | Delaybox; |

DB_TRANSACTION_TYPETransactionType;

} TransactionAnchorNode;

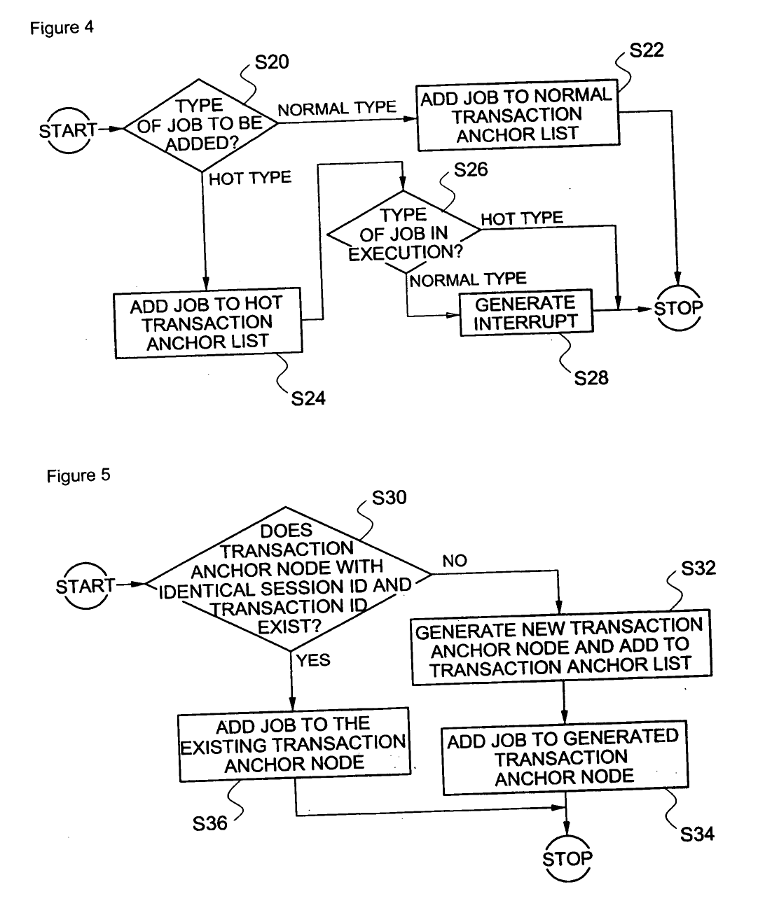

FIG. 4 illustrates a process of the job manager 30 transferring jobs to the mailbox 40 according to an embodiment of the present invention.

If a job requested by the application task 10 is received through the client API 20, the job manager 30 determines the type of the job based on the job type value (Job Type) included in the job request node in operation S20. If the job type value corresponds to a normal type, the job request node is added (stored) to the normal-type transaction anchor list in operation S22, and if the job type value corresponds to a hot type, the job request node is added (stored) to the hot-type transaction anchor list in operation S24. In addition, if the requested job is a hot type, an interrupt routine is called in operations S26 and S28. According to this, if the DB task performs a normal-type job, the execution is stopped and a job selected again through a job scheduling process by the job manager 30 is performed. If the DB task performs a hot-type job, the interrupt is ignored and the current hot-type job is performed continuously.

FIG. 5 illustrates in more detail a process (operation S22 or S24 of FIG. 4) of the job manager 30 adding (storing) jobs in a normal- or hot-type transaction anchor list according to an embodiment of the present invention. The job manager 30 assigns the session ID and transaction ID for a job which is requested to be processed, by using the ID of the application task requesting the job processing. In particular, when a transaction ID is assigned, if the jobs which are requested to be processed have identical session IDs, and at the same time, the requests for the processing are made between a time when a start of new transaction is declared, and a time when a normal completion or cancellation of the transaction is declared, identical transaction IDs are assigned or else, new transaction IDs are assigned. Through this process, a job request node desired to be added comes to have the session ID and transaction ID information of the job. Likewise, each transaction anchor node loaded in the mailbox 40 also has session ID and transaction ID information. When a job is added to a transaction anchor list, first, the job manager 30 identifies the session ID and transaction ID of the job to be added, and then the values are compared and analyzed sequentially with the session ID and transaction ID information of the entire transaction anchor nodes included in a corresponding transaction anchor list. By doing so, it is determined whether or not a transaction anchor node having the same session ID and transaction ID as those of the job to be added exists. If such a transaction anchor node exists, the job request node is added to the transaction anchor node, or else, a new transaction anchor is generated and added to the corresponding anchor list. Then, the job request node is added to the newly generated transaction anchor node. Since the job request node is added to the transaction anchor node in this manner, all job request nodes linked to one transaction anchor node become to have identical session IDs and transaction IDs. Job request nodes added to a transaction anchor node are managed in the form of a list. A job request node is added to a specific transaction anchor such that a pointer of the last job request node of the transaction anchor node indicates the newly added job request node. Accordingly, job request nodes belonging to an identical anchor node are linked through pointers and have a sequence.

The DB task 50 requests the mailbox 40 to transfer jobs to be processed, and receives and processes the jobs. At this time, the DB task 50 does not perform multiple jobs at the same time, but performs one job at a time. Jobs are performed in order in which jobs are loaded in the mailbox 40. In order to process jobs in a desired order, scheduling of jobs loaded in the mailbox 40 is needed.

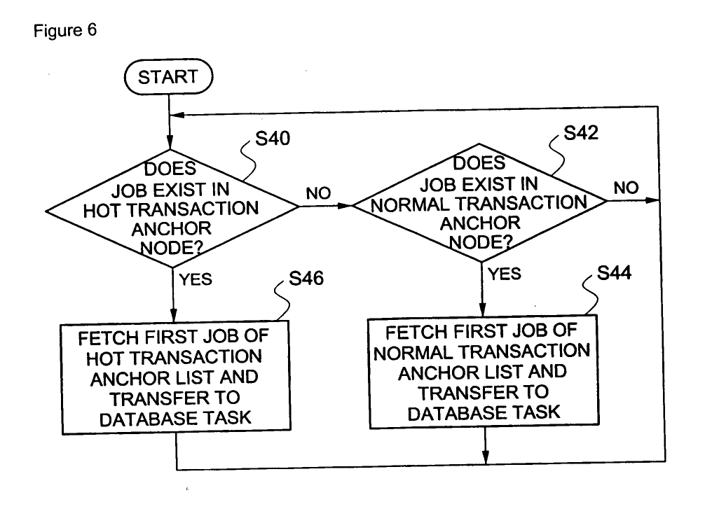

FIG. 6 illustrates a process of the job manager 30 scheduling jobs using the mailbox 40 according to an embodiment of the present invention. In a process of fetching jobs to be transferred to the DB task 50, the job manager schedules jobs in units of transactions. As the scheduling techniques employed, a preempt priority-based method and a non-preempt FIFO method for jobs of identical priorities are used concurrently. That is, if the transaction type of a job request node loaded in the mailbox 40 for the DB task 50 is a hot type, the job manager 30 calls an interrupt routine and schedules so that the job can be performed with a priority over normal-type jobs being performed but without a priority over other hot-type jobs being performed. If the transaction type of the job request node is a normal type, the job manager 30 schedules so that the job can be performed according to a FIFO method. The preempt priority-based method provides an opportunity to a job having a higher priority by restricting the operations of jobs having lower priorities. The present invention applies the preempt priority-based method between a normal-type transaction anchor list and a hot-type transaction anchor list so that jobs belonging to the hot-type transaction anchor list can always be performed with a priority over jobs belonging to the normal-type transaction anchor list. The non-preempt FIFO method makes a job requested earlier be processed earlier than a job requested later, without providing a priority to jobs additionally. The present invention applies the non-preempt FIFO method between jobs of identical types, that is, between jobs belonging to a normal-type transaction anchor list, or between jobs belonging to a hot-type transaction anchor list.

Transactions can be broken down into implicit transactions and explicit transactions. An implicit transaction corresponds to an execution of an ordinary SQL statement which does not use a transaction, and even in this case, the execution is processed as one transaction internally in the database. An explicit transaction corresponds to an execution of an SQL statement using a transaction. In this case, jobs belonging to an identical transaction have identical transaction IDs. In order to process from a job of a higher priority according to the preempt priority-based method, if a job exists in a hot-type transaction anchor list, the hot-type job is made to be transferred to the DB task 50 and processed. If no job exists in the hot-type transaction anchor list, a normal-type job in a normal-type transaction anchor list is made to be selected, transferred to the DB task 50, and processed. If an execution of one job is finished, a next job in the transaction anchor list classified as the same transaction as that of the finished job is made to be performed, and at the same time, the job request node of the finished job is deleted so that the finished job cannot remain in the transaction anchor list. According to the non-preempt FIFO method, when jobs having the same priorities and belonging to a hot-type transaction anchor list or a normal-type transaction anchor list are processed, a job requested earlier is selected, transferred to the DB task 50 and processed.

Among job request nodes loaded in the mailbox 40 of the DB task 50, those nodes forming an identical transaction have identical transaction IDs and are linked in sequence by pointers. The jobs of the identical transaction are continuously transferred to the DB task 50 through the job manager 30 and processed. Only when all the jobs having identical transaction IDs are successfully performed, the execution of the transaction is regarded as completed. In this manner, a job request is made by bundling jobs in units of transactions and if the transaction is failed, a roll-back is performed so that integrity of the database can be guaranteed.

If the processing of a job is finished, the processed result of the job is stored in a predetermined area of the memory pool 70, and the address information of the predetermined area and information (for example, the session ID and transaction ID) indicating the job are transferred to the job manager 30. The job manager 30 identifies an application task which is to receive the result, through the session ID included in the received job request node, and transfers the information to the mailbox 60 of each task. The processed result of the job loaded in the mailbox 60 is received later through a client API, and used by the application task 10 requesting the processing of the job, when the application task 10 obtains a control right from the RTOS.

In order to guarantee a real-time processing when the DB task 50 processes jobs, a time-out function is employed. According to this function, a job restriction time to be spent in processing one job is set. If a job is not finished within the job restriction time, the job being executed is stopped and the original state of data changed during the execution of the job is recovered and the recovered result is returned. Then, the job manager 30 is made to perform again a job scheduling process and a job selected according to the new scheduling is performed.

In addition to the time-out, a result which is transferred when the execution of a job is not normally completed due to a variety of errors includes an error message indicating the cause of the occurrence of an error.

With an example of the database installed in a mobile communication terminal running under an RTOS environment, optimum embodiments of the present invention have been explained above. However, it is apparent that variations and modifications by those skilled in the art can be effected within the spirit and scope of the present invention defined in the appended claims. For example, the present invention can be applied without being limited by the RTOS environment, or the database of a mobile communication terminal. For scheduling jobs in a database management system, the present invention can be applied without a restriction. Therefore, all variations and modifications equivalent to the appended claims are within the scope of the present invention.

According to the present invention, when jobs in relation to a database employed in a mobile communication terminal running under an RTOS environment are performed, an ordinary job is performed in order in which a job is requested, according to a FIFO method. However, in case of a job requiring urgent real-time processing, by setting a hot-type, an interrupt is generated and a job being executed previously is temporarily stopped so that the hot-type job can be processed with a priority. Then, after processing the hot-type job, the execution of the job temporarily stopped is resumed. By doing so, even in a mobile communication terminal environment in which processing of urgent jobs occurs quite frequently, real-time processing of jobs can always be guaranteed. Furthermore, by employing a time-out system, the real-time processing can be further guaranteed.

In addition, when a job processing is requested to a DB task, jobs are scheduled in units of transactions so that jobs can be processed in units of transactions. Accordingly, even though a database job in a mobile communication terminal having restricted resources is performed, the integrity of the database that is a general requirement of database jobs can be guaranteed perfectly.

Furthermore, by considering that a memory resource employed in a mobile communication terminal as a storage medium is limited, a concept of a memory pool that is shared as a common resource of tasks is introduced. By employing the memory pool, when an application task request a DB task to process a job, or the DB task transfer the processed result of the job to the application task, only addresses of the memory pool at which data actually required for processing the job or the actual processed result of the job is stored, needs to be exchanged, instead of exchanging the actual data of the job or the actual processed result. Accordingly, the processing of the job can be performed quickly and the limited memory resource can be utilized very efficiently. This provides a possibility that the present invention can be widely applied to the database jobs of other application devices whose memory resources are essentially limited.

What is claimed is:

1. A method of scheduling jobs using a database management system for real time processing, the method comprising:
an application task classifying a job which is requested to be processed at a database (DB) task, as any one transaction type of a hot type and a normal type, requesting a memory pool shared by tasks of the database management system, so that a processing area for the job is allocated, and then, requesting a database job manager to process the job, through a client application program interface (API);
the job manager identifying the type of transaction of the job which the application task requests to be processed, generating a job request node of the job, and loading the request node of the job in a list of a transaction type corresponding to the job, of a mailbox of the DB task, so that the job request node can be scheduled in units of transactions; and
the job manager transferring the job request nodes loaded in the mailbox for the DB task, one by one to the DB task so that the job request nodes can be processed in units of transactions in a manner in which a job corresponding to a hot-type transaction is processed with a priority over a job corresponding to a normal-type transaction, and between jobs of an identical truncation type, jobs are processed in order of job requesting time.

2. The method of claim 1, further comprising after the transferring and processing the job request nodes:
the DB task allocating the processed result of the job to the memory pool, and transferring the address of the memory pool in which the processed result is allocated, to the job manager, and
the job manager loading the received the memory pool address to the mailbox of the application task requesting the processing of the job, so that the corresponding application task obtaining a control right from the real-time operating system can use the processed result loaded in the mail box of the application task in the future.

3. The method of claim 1, further comprising:
if the DB task does not complete the received job within a job restriction time, the DB task stopping the job being performed, recovering the original state of data changed in the execution of the job, then, returning the recovering result to the job manager, and then performing a job selected by the job manager through a job scheduling process.

4. The method of claim 1, wherein if the transaction type of a job request node loaded in the mailbox is a hot type, the job manager calls an interrupt routine and schedules so that the job can be performed with a priority over normal-type jobs being performed but without a priority over other hot-type jobs being performed, and if the transaction type of the job request node is a normal type, the job manager schedules so that the job can be performed according to a first-in-first-out (FIFO) method.

5. The method of claim 1, wherein information exchanged between the application task and the job manager, and between the job manager and the DB task in order to request job processing and to receive the processing results of the jobs is address information of the memory pool at which the actual data required to process corresponding jobs and actual data as the processing results of the jobs are stored.

6. The method of claim 1, wherein the information included in a message transferred by the application task when the application task requests the job manager to process the job through the client API, comprises a structured query language (SQL) statement to be performed in order to process the job, an address of the memory pool at which the transaction type of the job and information on a restriction time (time-out) to be applied to the processing of the job are stored, and a primitive request that is an operation code to determine an execution method in the DB task.

7. The method of claim 1, wherein job request nodes loaded on the mailbox for the DB task, forming an identical transaction, have identical transaction IDs, and are sequentially linked by pointers, and when these jobs are transferred to the DB task through the job manager, jobs having identical transaction IDs, are made to be transferred continuously so that jobs can be bundled and processed in units of transactions.

8. The method of claim 1, wherein the mailbox of the DB task is disposed in a predetermined area of the memory pool, and has a structure, including a normal-type transaction anchor node list and a hot-type transaction anchor node list that are to classify a job as at least a normal type or a hot type with respect to the transaction type of the job and load the job,
and each transaction anchor node list is a linked list of transaction anchor nodes, and each transaction anchor node includes a list of job request nodes having information to perform jobs in units of transactions, a session ID to distinguish an application task requesting a job to be processed, a transaction ID used to process a job requested to be processed, as one processing unit, and a pointer to the mailbox of an application task to receive the processing result of the job.

9. The method of claim 1, wherein loading of a job request node in a list of a transaction type corresponding to the node, of the mailbox of the DB task so as to be scheduled in units of transactions, comprises:
identifying the session ID and transaction ID of a job to be added, then, comparing and analyzing sequentially the values with the session IDs and transaction IDs of the entire transaction anchor nodes included in a transaction anchor list corresponding to the job, and determining whether or not a transaction anchor node having the same session ID and transaction ID as those of the job to be added; and
if such a transaction anchor node exists, adding the job request node of the job to the transaction anchor node, and if such a transaction anchor does not exist, generating a new transaction anchor node, adding the new transaction anchor node to a corresponding transaction anchor list, and then, adding the job request node to the newly generated transaction anchor node. By doing so, jobs can be loaded in units of transactions.

10. The method of claim 1, wherein the session ID and transaction ID for a job which is requested to be processed are assigned by using the ID of the application task requesting the job processing, and in particular, when a transaction ID is assigned, if the jobs which are requested to be processed have identical session IDs, and at the same time, the requests for the processing are made between a time when a start of new transaction is declared, and a time when a normal completion or cancellation of the transaction is declared, identical transaction IDs are assigned, or else, new transaction IDs are assigned.

11. The method of claim 1, wherein the scheduling method is applied to an execution of a job in relation to a database management system installed in a mobile communication terminal running on a real-time operating system (RTOS).

12. A method of scheduling jobs for real time processing using a database management system installed in a mobile communication terminal running on a real-time operating system (RTOS), the method comprising:
an application task classifying a job which is requested to be processed at a database (DB) task, as any one transaction type of a hot type and a normal type, requesting a memory pool shared by tasks of the database management system, so that a processing area for the job is allocated, and then, requesting a database job manager to process the job, through a client application program interface (API);
the job manager identifying the type of transaction of the job which the application task requests to be processed, generating a job request node of the job, and loading the request node of the job in a list of a transaction type corresponding to the job, of a mailbox of the DB task, so that the job request node can be scheduled in units of transactions;
the job manager transferring the job request nodes loaded in the mailbox for the DB task, one by one to the DB task so that the job request nodes can be processed in units of transactions in a manner in which a job corresponding to a hot-type transaction is processed with a priority over a job corresponding to a normal-type transaction, and between jobs of an identical truncation type, jobs are processed in order of job requesting time;
the DB task allocating the processed result of the job to the memory pool, and transferring the address of the memory pool in which the processed result is allocated, to the job manager; and
the job manager loading the received the memory pool address to the mailbox of the application task requesting the processing of the job, so that the corresponding application task obtaining a control right from the real-time operating system can use the processed result loaded in the mail box of the application task in the future.

13. The method of claim 12, further comprising:
if the DB task does not complete the received job within a job restriction time, the DB task stopping the job being performed, recovering the original state of data changed in the execution of the job, then, returning the recovering result to the job manager, and then performing a job selected by the job manager through a job scheduling process.

14. The method of claim 12, wherein if the transaction type of a job request node loaded in the mailbox is a hot type, the job manager calls an interrupt routine and schedules so that the job can be performed with a priority over normal-type jobs being performed but without a priority over other hot-type jobs being performed, and if the transaction type of the job request node is a normal type, the job manager schedules so that the job can be performed according to a first-in-first-out (FIFO) method.

15. The method of claim 12, wherein information exchanged between the application task and the job manager, and between the job manager and the DB task in order to request job processing and to receive the processing results of the jobs is address information of the memory pool at which the actual data required to process corresponding jobs and actual data as the processing results of the jobs are stored.

15. The method of claim 13, wherein information exchanged between the application task and the job manager, and between the job manager and the DB task in order to request job processing and to receive the processing results of the jobs is address information of the memory pool at which the actual data required to process corresponding jobs and actual data as the processing results of the jobs are stored.

16. The method of claim 12, wherein the information included in a message transferred by the application task when the application task requests the job manager to process the job through the client API, comprises a structured query language (SQL) statement to be performed in order to process the job, an address of the memory pool at which the transaction type of the job and information on a restriction time (time-out) to be applied to the processing of the job are stored, and a primitive request that is an operation code to determine an execution method in the DB task.

17. The method of claim 12, wherein job request nodes loaded on the mailbox for the DB task, forming an identical transaction, have identical transaction IDs, and are sequentially linked by pointers, and when these jobs are transferred to the DB task through the job manager, jobs having identical transaction IDs, are made to be transferred continuously so that jobs can be bundled and processed in units of transactions.

18. The method of claim 12, wherein the mailbox of the DB task is disposed in a predetermined area of the memory pool, and has a structure, including a normal-type transaction anchor node list and a hot-type transaction anchor node list that are to classify a job as at least a normal type or a hot type with respect to the transaction type of the job and load the job,
and each transaction anchor node list is a linked list of transaction anchor nodes, and each transaction anchor node includes a list of job request nodes having information to perform jobs in units of transactions, a session ID to distinguish an application task requesting a job to be processed, a transaction ID used to process a job requested to be processed, as one processing unit, and a pointer to the mailbox of an application task to receive the processing result of the job.

19. The method of claim 12, wherein loading of a job request node in a list of a transaction type corresponding to the node, of the mailbox of the DB task so as to be scheduled in units of transactions, comprises:
identifying the session ID and transaction ID of a job to be added, then, comparing and analyzing sequentially the values with the session IDs and transaction IDs of the entire transaction anchor nodes included in a transaction anchor list corresponding to the job, and determining whether or not a transaction anchor node having the same session ID and transaction ID as those of the job to be added; and
if such a transaction anchor node exists, adding the job request node of the job to the transaction anchor node, and if such a transaction anchor does not exist, generating a new transaction anchor node, adding the new transaction anchor node to a corresponding transaction anchor list, and then, adding the job request node to the newly generated transaction anchor node. By doing so, jobs can be loaded in units of transactions.

20. The method of claim 12, wherein the session ID and transaction ID for a job which is requested to be processed are assigned by using the ID of the application task requesting the job processing, and in particular, when a transaction ID is assigned, if the jobs which are requested to be processed have identical session IDs, and at the same time, the requests for the processing are made between a time when a start of new transaction is declared, and a time when a normal completion or cancellation of the transaction is declared, identical transaction IDs are assigned, or else, new transaction IDs are assigned.
